(19) United States
(12) Patent Application Publication
(10) Pub. No.: US 2026/0196243 A1
(43) Pub. Date: Jul. 9, 2026

(54) DISK DEVICE

(71) Applicants: Kabushiki Kaisha Toshiba, Tokyo (JP); Toshiba Electronic Devices & Storage Corporation, Tokyo (JP)

(72) Inventor: Tomoyuki TOKIZAKI, Yokohama Kanagawa (JP)

(21) Appl. No.: 19/179,787

(22) Filed: Apr. 15, 2025

(30) Foreign Application Priority Data
Jan. 6, 2025 (JP) 2025-000047

(51) Int. Cl. G11B 5/48

(52) U.S. Cl. CPC G11B 5/4813

(57) ABSTRACT

According to one embodiment, a disk device includes a coil motor that pivots an actuator assembly around a support shaft extending in a first direction. The actuator assembly has a first center axis passing through the center between a pair of bearings and perpendicular to the support shaft. The coil motor includes a lower magnet and an upper magnet, and a voice coil fixed to the actuator assembly and located between the lower magnet and the upper magnet. The voice coil has a coil center axis that extends parallel to the first center axis through the center of the first direction, and is arranged at a height position where the coil center axis is offset in the first direction with respect to the first center axis.

### CROSS-REFERENCE TO RELATED APPLICATIONS

This application is based upon and claims the benefit of priority from Japanese Patent Application No. 2025-000047, filed Jan. 6, 2025, the entire contents of which are incorporated herein by reference.

### FIELD

Embodiments described herein relate generally to a disk device.

### BACKGROUND

As a disk drive, for example, a hard disk drive (HDD) comprises a rotatable magnetic disk and a rotatable actuator assembly (which may as well be referred to as a head stack assembly (HSA)) that supports a magnetic head, both of which are provided in a housing. Further, in the housing, a voice coil motor (VCM) that pivots and positions the actuator assembly is provided.

The VCM contains two magnets provided on upper and lower sides, respectively, in the housing and a voice coil fixed to the actuator assembly. The voice coil is movably disposed between the two magnets.

Usually, the VCM containing the magnets and the voice coil is configured and arranged symmetrically in upper and lower directions, but it may be configured vertically asymmetrically depending on the arrangement and layout of the structural components of the HDD. For example, the upper and lower magnets may differ in thickness from each other.

However, when the VCM is configured vertically asymmetrically, an upper and lower exciting force is generated in the voice coil, and the voice coil is excited in the upper and lower directions. The excitation of the voice coil is transmitted to the actuator assembly, and pitching vibration of the actuator occurs. Here, there is a concern that residual vibration due to the pitching vibration will adversely affect the accuracy of positioning the magnetic head.

### BRIEF DESCRIPTION OF THE DRAWINGS

FIG. 1 is an exploded perspective view showing a hard disk drive (HDD) according to the first embodiment when a top cover thereof is removed.

FIG. 2 is a plan view of the HDD.

FIG. 3 is a perspective view showing a rear surface side of the HDD.

FIG. 4 is a perspective view showing an actuator assembly and an FPC unit of the HDD.

FIG. 5 is a cross-sectional view of the HDD, including a bearing unit of the actuator assembly, a voice coil motor (VCM), and a spindle shaft of a spindle motor of the HDD.

FIG. 6A is a perspective view showing magnets and yokes of the VCM.

FIG. 6B is a diagram schematically showing respective magnetization directions of the magnets.

FIG. 7 is a diagram illustrating a direction of a force acting on the voice coil of the VCM.

FIG. 8 is a diagram schematically showing a relationship between an exciting force component generated in the voice coil and a pitching torque.

FIG. 9 is a diagram schematically showing a relationship between other exciting force component generated in the voice coil and the pitching torque.

FIG. 10 is a diagram showing results of analysis of the pitching torque for three types of HDDs having different coil heights to be compared.

FIG. 11 is a plan view schematically showing the above-mentioned actuator assembly and VCM in a state where they are pivoted to an inner circumferential side of the magnetic disk.

FIG. 12 is a plan view schematically showing the above-mentioned actuator assembly and VCM in a state where they are pivoted to an outer circumferential side of the magnetic disk.

FIG. 13 is a diagram schematically showing a relationship between an overlapping width between the voice coil and magnet and a magnitude of the force Fx generated in the voice coil.

FIG. 14 is a cross-sectional view showing an HDD according to the second embodiment, including a bearing unit of an actuator assembly, a voice coil motor (VCM), and a spindle shaft of a spindle motor.

FIG. 15 is a cross-sectional view showing an HDD according to the third embodiment, including a bearing unit of an actuator assembly, a voice coil motor (VCM), and a spindle shaft of a spindle motor.

### DETAILED DESCRIPTION

Various embodiments will be described hereinafter with reference to the accompanying drawings. In general, according to one embodiment, a disk drive comprises a housing including a base with a bottom wall and a cover opposing the bottom wall, a disk-shaped recording medium provided to be rotatable in the housing, a head which performs information processing on the recording medium, an actuator assembly including an actuator block supported to be rotatable by a pair of bearings on a support shaft extending in a first direction and provided to stand upright on the bottom wall, a suspension assembly extending from the actuator block in a direction intersecting the support shaft, on which the head is mounted, and a support frame extending from the actuator block, and a coil motor which pivots the actuator assembly. The coil motor comprises a lower yoke provided on the bottom wall, a lower magnet provided on the lower yoke, an upper yoke opposing the lower yoke at an interval therebetween in the first direction, an upper magnet provided on the upper yoke and opposing the lower magnet at an interval in the first direction, and a voice coil fixed to the support frame of the actuator assembly and located between the lower magnet and the upper magnet, and the upper magnet and the lower magnet are different from each other in thickness in the first direction, the actuator assembly includes a first center axis passing through a center between the pair of bearings and perpendicular to the support shaft, and the voice coil includes a coil center axis extending parallel to the first center axis while passing through the center in the first direction, and the coil center axis is disposed at a height position offset in the first direction with respect to the first center axis.

Note that the disclosure is merely an example, and proper changes in keeping with the spirit of the invention, which are easily conceivable by a person of ordinary skill in the art, come within the scope of the invention as a matter of course. In addition, in some cases, in order to make the description clearer, the drawings show schematic illustration rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

### First Embodiment

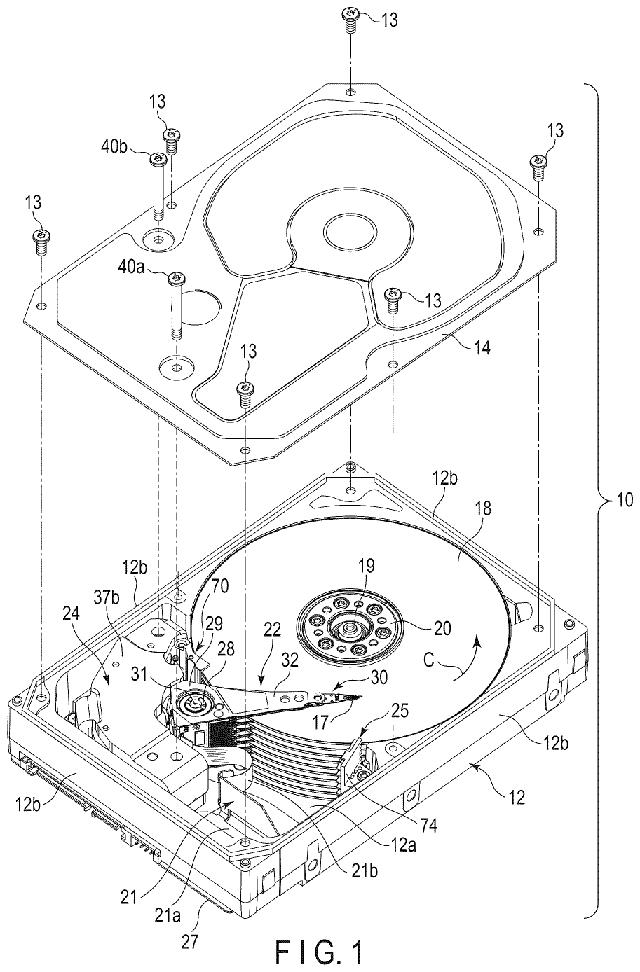

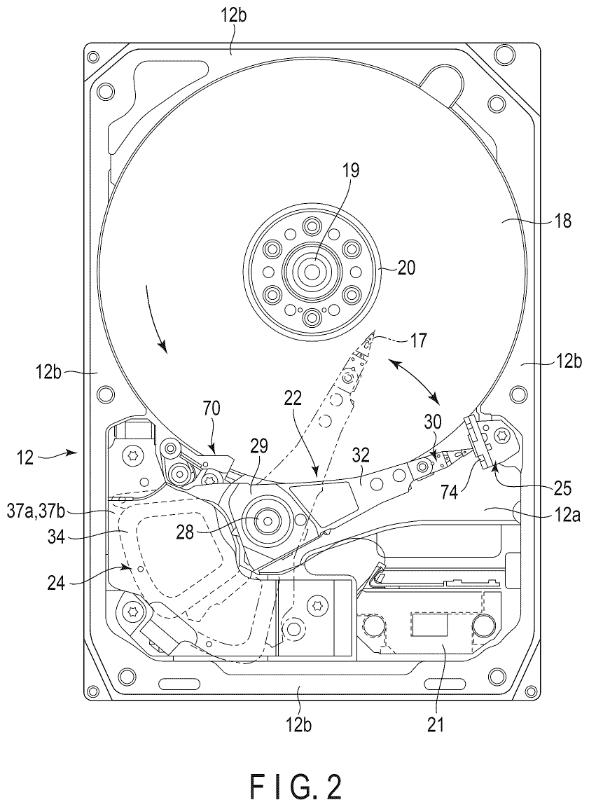

As a disk device, a hard disk drive (HDD) according to the first embodiment will be described in detail. FIG. 1 is an exploded perspective view of the HDD of the first embodiment, when a cover thereof is removed, and FIG. 2 is a plan view of the HDD when the cover is removed.

As shown in FIG. 1, the HDD comprises a substantially rectangular-shaped housing 10. The housing 10 includes a rectangular box-shaped base 12 whose upper surface is open, and a cover (top cover) 14 that is screwed to the base 12 with multiple screws 13 and closes the upper opening of the base 12. The base 12 includes a rectangular bottom wall 12a opposing the cover 14 with a gap therebetween and side walls 12b that stand upright along the peripheral edges of the bottom wall 12a. The side walls 12b include a pair of long side walls that oppose each other and a pair of short side walls that oppose each other. The cover 14 is formed into a rectangular plate-shape from, for example, stainless steel. The cover 14 is screwed to the top surface of the side walls 12b by its peripheral edges using screws 13.

Inside the housing 10, there are a plurality of, for example, ten magnetic disks 18, and a spindle motor 19 that supports and rotates the magnetic disks 18 provided therein. The spindle motor 19 is disposed on the bottom wall 12a. Each of the magnetic disks 18 is formed, for example, as a circular disk having a diameter of 96 mm (3.5 inches), and includes a substrate made of, for example, a non-magnetic material such as glass or aluminum, and magnetic recording layers formed respectively on an upper surface (first surface) and a lower surface (second surface) of the substrate. The magnetic disks 18 are fitted to be coaxial with each other onto the hub of the spindle motor 19, and further they are clamped by a clamp spring 20. With this configuration, the magnetic disks 18 are supported in a state where they are positioned parallel to the bottom wall 12a of the base 12. The magnetic disks 18 are rotated at a predetermined speed by the spindle motor 19. Note that the number of magnetic disks 18 mounted is not limited to ten, but it may as well be nine or less, or eleven or more.

As shown in FIGS. 1 and 2, the housing 10 contains a plurality of magnetic heads 17 that perform recording and reproduction of data with respect to the respective magnetic disks 18, and an actuator assembly (which may as well be in some cases referred to as a head stack assembly (HSA)) 22 that supports these magnetic heads 17 movably with respect to the respective magnetic disks 18. Further, inside the housing 10, there are a voice coil motor (VCM) 24 that pivots and positions the actuator assembly 22, a ramp load mechanism 25 that holds the respective magnetic head 17 in an unloaded position separated from the respective magnetic disk 18 when the magnetic head 17 is moved to the outermost circumference of the magnetic disk 18, a substrate unit (FPC unit) 21 on which electronic components such as conversion connectors are mounted, and a spoiler 70. The ramp load mechanism 25 includes a ramp 74 fixed to the base 12. Note that the actuator assembly 22 and the VCM 24 constitute the head actuator.

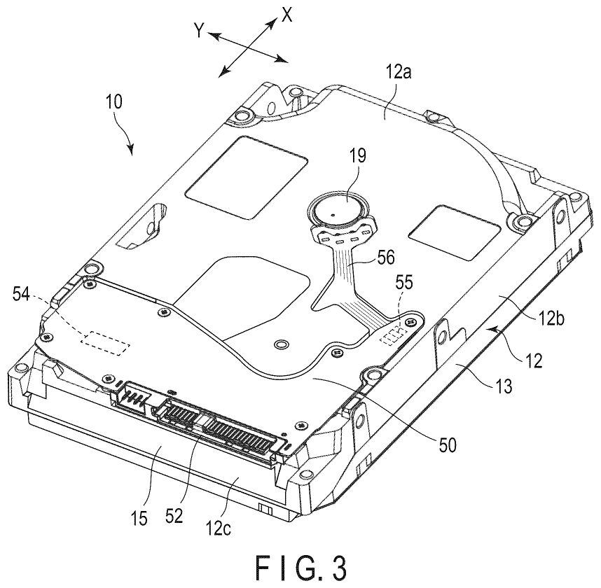

FIG. 3 is a perspective view of the rear surface side of the HDD. As shown in the figure, a printed circuit board (which may as well be in some cases referred to as a control circuit board) 50 is installed on the outer surface of the bottom wall 12a of the base 12 and is fixed to the bottom wall 12a by means of multiple screws. In this embodiment, the printed circuit board 50 is formed to have a size of about ⅓ of the area of the bottom wall 12a. The printed circuit board 50 is placed in a shallow recess portion formed in the bottom wall 12a. The printed circuit board 50 is provided in the region of the bottom wall 12a, which opposes the VCM 24, and located to be offset from the region opposing the respective magnetic disk 18. That is, the printed circuit board 50 does not overlap the region opposing the magnetic disk 18.

The printed circuit board 50 has an end edge that is aligned with one of the short sides of the bottom wall 12a (the short side that is further distant from the magnetic disk 18), and a pair of side edges that extend substantially orthogonal from the end edge and are substantially aligned with a pair of long sides of the bottom wall 12a. The printed circuit board 50 has an outer surface that is exposed to the outside and an inner surface on the opposite side. The printed circuit board 50 is attached to the base 12 in a state where the inner surface thereof opposes the bottom wall 12a.

On the inner surface of the printed circuit board 50, there are an interface connector 52 connected to an external device, a relay connector 54 connected to a connector on a base 12 side, a connector terminal unit 55 connected to the spindle motor 19, and other electronic components not shown in the figure, mounted thereon. The printed circuit board 50 constitutes a control circuit board (control unit) that controls the operation of the spindle motor 19 and further controls the operation of the VCM 24 and the respective magnetic head 17 via the FPC unit 21 as well.

The interface connector 52 is mounted along the end edge of the printed circuit board 50. The relay connector 54 is electrically connected to the substrate unit 21 via a relay connector (not shown) provided on the side of the bottom wall 12a. The connector terminal 55 is connected to one end of the connection FPC 56 affixed to the bottom wall 12a. The other end of the connection FPC 56 is electrically connected to the spindle motor 19. With this configuration, the printed circuit board 50 is electrically connected to the substrate unit 21 and the spindle motor 19.

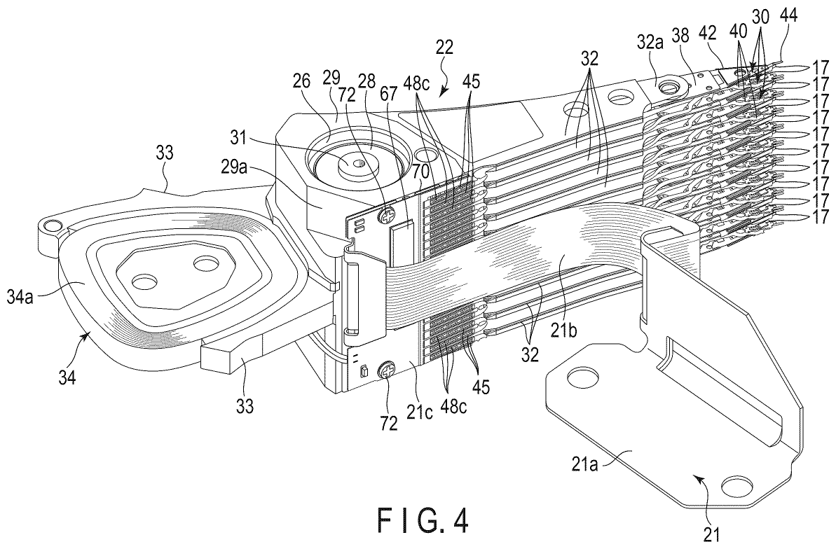

FIG. 4 is a perspective view showing the actuator assembly and the substrate unit. As shown in the figure, the actuator assembly 22 comprises an actuator block 29 having a through hole 26, a bearing unit (unit bearing) 28 provided in the through hole 26, a plurality of, for example, eleven arms 32 extending from the actuator block 29, suspension assemblies (head gimbal assemblies: each may as well be in some cases referred to as an HGA) 30 attached to the arms 32, respectively, and magnetic heads 17 supported by the suspension assemblies 30, respectively. A support shaft (pivot shaft) 31 is provided to stand upright on the bottom wall 12a of the base 12. The support shaft 31 is provided to stand upright to be substantially parallel to the rotation axis of the spindle motor 19. That is, the support shaft 31 extends out in a height direction Z (which may as well be in some cases referred to as the first direction) as will be described later. The actuator block 29 is supported so as to be rotatable around the support shaft 31 by the bearing unit 28.

In this embodiment, the actuator block 29 and the eleven arms 32 are molded to be integrated as one body from aluminum or the like to constitute a so-called E-block. The arms 32 are each formed into, for example, a slender flat plate, and extend from the actuator block 29 in a direction perpendicular to the support shaft 31. The eleven arms 32 are provided in parallel with each other while having gaps therebetween.

The actuator assembly 22 includes a two-way support frame 33 that extends from the actuator block 29 in a direction opposite to the arms 32. The support frame 33 extends from the actuator block 29 in a direction orthogonal to the support shaft 31. The voice coil 34 is supported by the support frame 33. The voice coil 34 constitutes a part of the VCM 24. The voice coil 34 is arranged to be directed so that its winding center axis CF extends in a direction that is approximately parallel to the support shaft 31.

As shown in FIGS. 1 and 2, the voice coil 34 is located between a pair of yokes 37a and 37b, one of which is fixed to the base 12, and constitutes the VCM 24 together with the permanent magnets fixed to these yokes 37a and 37b, respectively.

As shown in FIG. 4, the actuator assembly 22 has twenty suspension assemblies 30, each of which supports the respective magnetic head 17. The suspension assemblies 30 are each attached to an extending end 32a of the respective arm 32. The suspension assemblies 30 include an up-head suspension assembly that supports the respective magnetic head 17 in an upward direction and a down-head suspension assembly that supports the respective magnetic head 17 in a downward direction. The up-head suspension assemblies and down-head suspension assemblies are configured by changing the arrangement of suspension assemblies 30 of the same structure in an upside-down orientation.

In this embodiment, as shown in FIG. 4, the down-head suspension assembly 30 is attached to the uppermost arm 32, and the up-head suspension assembly 30 is attached to the lowermost arm 32. The up-head suspension assembly 30 and the down-head suspension assembly 30 are attached to each of the nine intermediate arms 32.

The suspension assemblies 30 each include a substantially rectangular-shaped base plate 38, a load beam 42 made from a slender plate spring, and a slender strip-like flexure (wiring member) 40. The flexure 40 has a displaceable gimbal portion, and the magnetic head 17 is placed on the gimbal portion. The base plate 38 is fixed by its distal end portion to the extending end 32a of the arm 32. The load beam 42 extends from the base plate 38 and is formed to tapered down towards the extending end. The base plate 38 and the load beam 42 are formed, for example, of stainless steel. A tab 44 protrudes from the distal end of the load beam 42. The tab 44 can engage with the ramp 74 described above, and together with the ramp 74, the load beam 42 forms the ramp load mechanism 25.

As shown in FIG. 4, the FPC unit 21 includes a substantially rectangular base unit 21a bent into an L shape, a slender strip-shaped relay unit 21b extending from one side edge of the base 21a, and a joint unit 21c provided continuously at the distal end of the relay unit 21b, all integrated as one body. The base unit 21a, the relay unit 21b, and the joint unit 21c are formed from a flexible printed circuit board (FPC). The flexible printed circuit board has an insulating layer such as of polyimide, a conductive layer having multiple wiring lines, connection pads, and the like, formed on the insulating layer, and a protective layer covering the conductive layer.

On the base unit 21a, electronic components such as conversion connectors and multiple capacitors, which are not shown in the figure, are mounted and electrically connected to the wiring lines, which are not shown in the figure. The relay unit 21b extends from the side edge of the base unit 21a toward the actuator block 29 of the actuator assembly 22. The joint unit 21c provided at the extending end of the relay unit 21b is affixed to the installation surface of the actuator block 29 and is further fixed by screw to the installation surface using a fixing screw 72. A plurality of connection pads are provided on the joint unit 21c. For example, one head IC (head amplifier) 67 is mounted on the joint unit 21c, and this head IC 67 is connected to the connection pads and the base unit 21a via wiring lines. Further, the voice coil 34 is connected to the joint unit 21c.

The flexure 40 of each suspension assembly 30 has an end electrically connected to the respective magnetic head 17, another end that extends to the actuator block 29 through a groove formed in the side edge of the respective arm 32, and a connection end (tail connection terminal) 48c provided at the other end. The connection end 48c is formed into a slender rectangle shape. At the connection end 48c, a plurality of connection terminals (connection pads) 45 are provided. These connection terminals 45 are connected respectively to the wiring lines of the flexure 40. That is, the wiring lines of the flexure 40 extend over substantially the entire length of the flexure 40, and one end of each is electrically connected to the magnetic head 17, while the other end is connected to the respective connection terminal (connection pad) 45.

The connection terminal 45 provided at the connection end 48c is joined to the connection pad of the joint unit 21c, and is electrically connected to the wiring line of the joint unit 21c via the connection pad. With this connection, the twenty magnetic heads 17 of the actuator assembly 22 are electrically connected to the base unit 21a via the wiring lines of the flexure 40, the connection end 48c, the joint unit 21c of the FPC unit 21, and the relay unit 21b.

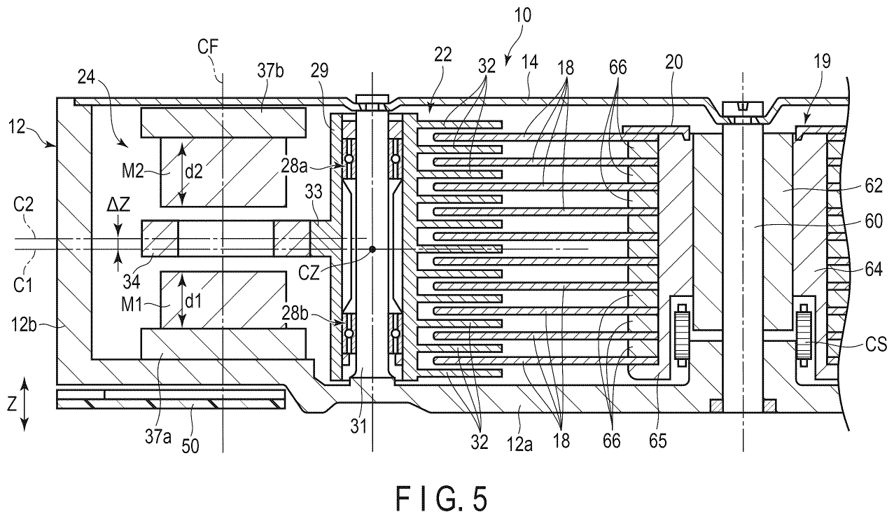

FIG. 5 is a cross-sectional view of an HDD, including the bearing unit of the actuator assembly, the voice coil motor (VCM), and the spindle shaft of the spindle motor.

As shown in FIG. 5, the support shaft 31 of the actuator assembly 22 is provided to stand upright on the inner surface of the bottom wall 12a and extends in the Z direction perpendicular to the bottom wall 12a. The support shaft 31 is inserted through the through hole 26 of the actuator block 29. The actuator block 29 is supported by the bearing unit 28 so as to be freely rotatable around the support shaft 31.

The bearing unit 28 includes a plurality of, for example, two bearings 28a and 28b. The bearing 28a is engaged with the end on a cover 14 side of the support shaft 31. The bearing 28b is engaged with the end on a bottom wall 12a side of the support shaft 31. The two bearings 28a and 28b are installed at a predetermined distance from each other. A center CZ in the height direction Z between the bearing 28a and bearing 28b is the center of the actuator assembly 22 in the height direction. When the axial line extending in the direction perpendicular to the Z direction through the center CZ is defined as the center axis (which may as well be in some cases referred to as the first center axis) C1, the center axis C1 extends through the arm 32 located in the center position among the eleven arms 32 in the height direction Z.

The support frame 33 of the actuator assembly 22 extends in a direction perpendicular to the height direction Z. The voice coil 34 supported by the support frame 33 is disposed in a state where its winding center axis CF is positioned parallel to the support shaft 31. Further, according to this embodiment, when the line that extends in a direction perpendicular to the Z direction while passing through the center of the voice coil 34 in the height direction Z (thickness direction) is defined as a center axis (which may as well be in some cases referred to as the coil center axis) C2, the voice coil 34 and the support frame 33 are disposed such that the center axis C2 of the voice coil 34 is offset by ΔZ in the height direction Z with respect to the center axis C1 of the actuator assembly 22. The center axis C2 of the voice coil 34 is located to be offset by ΔZ in the upper direction (towards the cover 14 side) with respect to the center axis C1 of the actuator assembly.

As shown in FIG. 5, the spindle motor 19 includes a pivot shaft (spindle shaft) 60 provided to stand upright substantially perpendicularly to the bottom wall 12a, a cylindrical rotating shaft 62 supported to be freely rotatable around the pivot shaft 60, a cylindrically shaped hub 64 fixed to be coaxial around the rotating shaft 62, a stator coil SC fixed to the bottom wall 12a and arranged around the rotating shaft 62, and a cylindrical magnet (not shown) attached to the inner circumferential surface of the hub 64 and opposing the stator coil SC. The hub 64 has an outer circumferential surface located to be coaxial with the pivot shaft 60 and an annular ring-shaped flange 65 formed to be integrated with the lower end (end on the bottom wall 12a side) of the outer circumferential surface.

The magnetic disks 18 are engaged with the outer circumference of the hub 64 in a state where the hub 64 is inserted through the inner holes of the magnetic disks 18. Annular ring-shaped spacer rings 66 are attached to the outer circumferential surface of the hub 64 and are each interposed between each respective adjacent pair of magnetic disks 18. The magnetic disks 18 and the spacer rings 66 are arranged in order on the flange 65 of the hub 64 and attached to the hub 64 in such a manner that they alternately overlap each other. A disk-like clamp spring 20 is attached to the upper end of the hub 64. The clamp spring 20 presses the inner circumferential portions of the magnetic disks 18 and the spacer rings 66 toward the flange 65. With this configuration, the magnetic disks 18 are fixed in a stacked state with predetermined intervals therebetween. Ten magnetic disks 18 are supported in a manner that allows them to rotate together with the rotating shaft 62 and the hub 64. Ten magnetic disks 18 are supported at predetermined intervals in parallel with each other and approximately parallel to the bottom wall 12a.

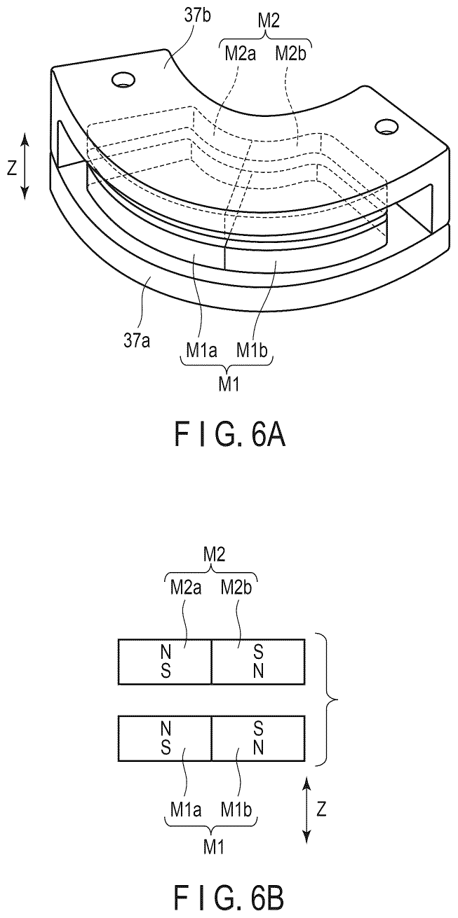

FIG. 6A is a perspective view showing the permanent magnets and yokes of the VCM, and FIG. 6B is a diagram schematically showing the magnetization direction of the permanent magnets.

As shown in FIGS. 1, 5, and 6A, the VCM 24 includes a lower yoke 37a and an upper yoke 37b provided on the bottom wall 12a of the base 12, and a lower magnet M1 and an upper magnet M2 respectively fixed to these yokes.

As mentioned above, the printed circuit board 50 is provided in a region opposing the VCM 24, which may affect the mounting space of the VCM 24 in terms of the vertical direction Z.

The lower yoke 37a is constituted by an approximately circular arc-shaped flat plate. The lower yoke 37a is disposed on the bottom wall 12a and is fixed to the bottom wall 12a. The lower yoke 37a is disposed along the corner portions of the bottom wall 12a.

The upper yoke 37b includes a flat plate having substantially the same shape as that of the lower yoke 37a, and a pair of leg portions extending from both ends of the flat plate. The upper yoke 37b is arranged to be overlaid on the lower yoke 37a in the state where the pair of leg portions abut against the lower yoke 37a. Further, the upper yoke 37b and the lower yoke 37a are fixed to the bottom wall 12a by two fixing screws 40a and 40b. The upper yoke 37b is provided to oppose the lower yoke 37a at a predetermined interval in the height direction Z.

In one example, a lower magnet M1 is fixed to the upper surface of the lower yoke 37a, and an upper magnet M2 is installed on the lower surface of the upper yoke 37b. The lower magnet M1 and the upper magnet M2 are provided at a predetermined interval therebetween so as to oppose in parallel with each other.

The lower magnet M1 is divided into two magnetization regions M1a and M1b at the center position in the circumferential direction. As shown in FIG. 6B, the lower magnet M1 is magnetized in such a way that the magnetization direction of the magnetization region M1a and the magnetization direction of the magnetization region M1b are opposite to each other in the height direction (thickness direction) Z.

The upper magnet M2 is divided into two magnetization regions M2a and M2b at the center position in the circumferential direction. As shown in FIG. 6B, the upper magnet M2 is magnetized in such a way that the magnetization direction of the magnetization region M2a and the magnetization direction of the magnetization region M2b are opposite to each other in the height direction (thickness direction) Z. The magnetization regions M2a and M2b of the upper magnet M2 have the same shape as that of the magnetization regions M1a and M1b of the lower magnet M1, respectively, except for the thickness, and are located to oppose the magnetization regions M1a and M1b, respectively.

As shown in FIG. 5, according to this embodiment, the lower magnet M1 has a thickness d1 in the height direction Z, which is different from a thickness d2 of the upper magnet M2 in the height direction Z. In one example, the upper magnet M2 is thicker than the lower magnet M1, which can be expressed as d1<d2. For example, d1 is 3.3 mm and d2 is 4.3 mm.

The voice coil 34 supported by the actuator assembly 22 is located between the lower magnet M1 and the upper magnet M2 so as to oppose the lower magnet M1 and upper magnet M2. The voice coil 34 is moved in the circumferential direction between the lower magnet M1 and the upper magnet M2 around the support shaft 31 as the actuator assembly 22 is pivoted.

As described above, the voice coil 34 is placed such that its center axis C2 is located offset by ΔZ in the height direction Z with respect to the center axis C1 of the actuator assembly 22. In this embodiment, the voice coil 34 is disposed offset by AZ towards the thicker magnet, that is, the upper magnet M2, with respect to the center axis C1 of the actuator assembly 22. With this configuration, the center axis C2 of the voice coil 34 is located at the center in the height direction Z of the distance between the lower magnet M1 and the upper magnet M2 in the height direction Z.

In the HDD configured as described above, when a drive current is passed through the voice coil 34 of the VCM 24, a circumferential force is generated by the interaction with the magnetic fields generated from the lower magnet M1 and upper magnet M2, and the actuator assembly 22 is rotated around the support shaft 31 together with the voice coil 34.

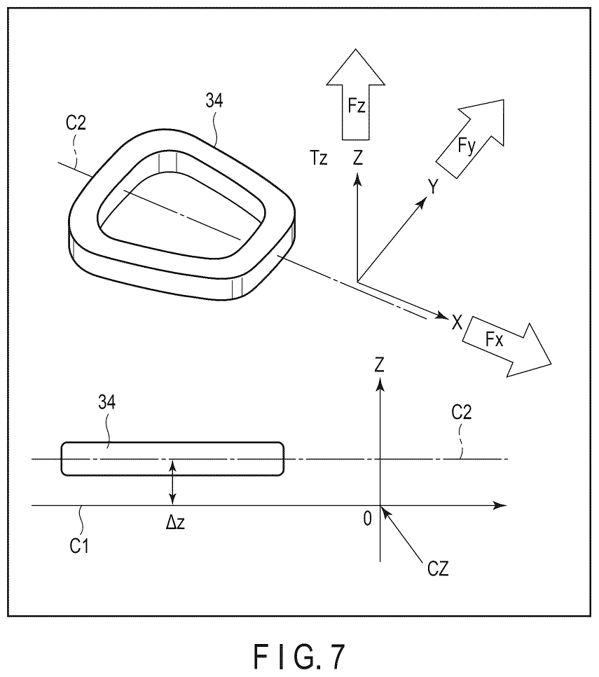

FIG. 7 is a diagram schematically showing the force acting on the voice coil 34 when it is driven.

In order to discuss the force and torque generated in the voice coil 34, a coordinate system is defined in FIG. 7. Here, the center between the bearings 28a and 28b is defined as an origin CZ, the direction parallel to the longitudinal axis of the voice coil is defined as an X axis, the height direction is defined as a Z axis, and a lateral direction perpendicular to both is defined as a Y axis. Of the resultant force of the force generated by the voice coil, the thrust that pivots the actuator assembly 22 around the support shaft is denoted by Fy. In contrast, Fx and Fz do not contribute to the pivotal performance of the actuator assembly 22, and Fz is the exciting force in the height direction Z (up and down direction).

As shown in FIG. 7, when current is passed through the voice coil 34, the resultant force Fx in the longitudinal direction (axial direction) X and the resultant force Fy in the direction Y, which is perpendicular to the longitudinal direction X are generated as the resultant force in a coil surface direction. Further, when the lower magnet M1 and the upper magnet M2 are formed asymmetrically, for example, when one magnet is formed thicker than the other, an exciting force in an out-of-plane direction of the voice coil 34, that is, here, an exciting force Fz in the Z direction is generated. The exciting force Fz in the out-of-plane direction may be a factor that generates a pitching torque in the actuator assembly 22.

Accordingly, in the present embodiment, as described above, the voice coil 34 is arranged such that its center axis C2 is located offset by ΔZ in the Z direction with respect to the center axis C1 of the actuator assembly 22, that is, the center axis C1 passing through the center between the bearings 28a and 28b.

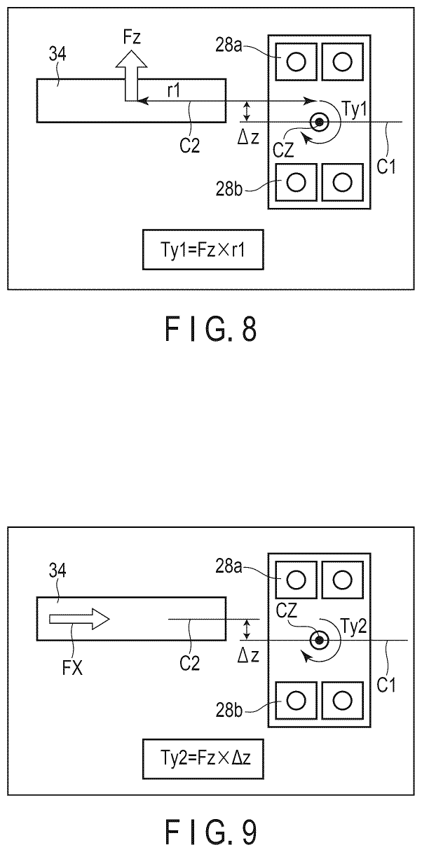

FIG. 8 is a diagram schematically showing the relationship between the exciting force Fz in the height direction Z generated in the voice coil and the pitching torque. FIG. 9 is a diagram schematically showing the relationship between the resultant force Fx in the longitudinal direction X generated in the voice coil and the pitching torque.

As shown in FIG. 8, when the exciting force in the height direction Z is defined as Fz, and the distance between the center position of the distribution force that makes up Fz and the center CZ between the bearings 28a and 28b is defined as r1, the pitching torque Ty1 around the Y axis (axis that passes through the center CZ and is perpendicular to the longitudinal direction X) of the actuator assembly 22 caused by the exciting force Fz is defined by:

$$Ty 1 = Fz \times r 1.$$

As shown in FIG. 9, when the resultant force in the longitudinal direction X is Fx, and the offset amount in the height direction Z of the center axis C2 of the voice coil 34 is ΔZ, the pitching torque Ty2 of the actuator assembly 22 around the Y axis, caused by the resultant force Fx is obtained by: Ty2=Fx×ΔZ.

When the height of the center axis C2 of the voice coil 34 is the same as the height of the center CZ between the bearings, FX is simply a translational force, but when there is a height difference ΔZ, a moment is generated due to FX, and a pitching torque Ty2 is generated.

In this embodiment, the force generated by the VCM 24 and the height difference ΔZ are adjusted so that the two pitching torques Ty1 and Ty2 described above cancel each other out. Since the absolute value of the pitching torque Ty1 is large at the inner circumferential position and outer circumferential position of the magnetic disk, it is preferable to reduce the pitching torque at the inner circumferential position or outer circumferential position of the magnetic disk.

According to this embodiment, in order to cancel out the generated torque at the inner circumferential position of the magnetic disk, ΔZ is adjusted such that the magnitudes of the two pitching torques Ty1 and Ty2 become substantially the same as each other and their directions become opposite to each other.

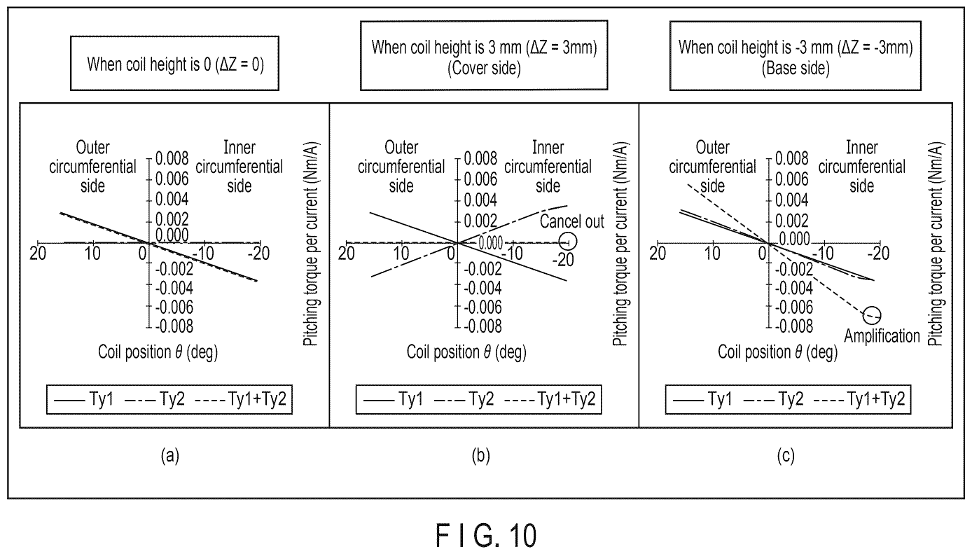

FIG. 10 is a diagram showing comparisons in the changes in pitching torque for three examples (a), (b), and (c) in which the voice coil 34 have height offsets ΔZ different from each other.

FIG. 10, in part (a), shows results of the analysis for the case where the height offset ΔZ in the pitching torque of the voice coil 34 is 0 (ΔZ=0). When the height offset is zero, the resultant force Fx in the longitudinal direction X is simply a translational force, and therefore the pitching torque Ty2 is not generated. Therefore, it can be seen that only the pitching torque Ty1 caused by the exciting force Fz in the height direction Z is generated on the outer circumferential side and inner circumferential side of the magnetic disk.

FIG. 10, in part (b), shows results of the analysis for the case where the height offset of the pitching torque of the voice coil 34 is 3 mm toward the cover (ΔZ=3 mm). In this case, the pitching torques Ty1 and Ty2 occur on the outer circumferential side and inner circumferential side of the magnetic disk, respectively, at substantially the same magnitude and in opposite directions. As a result, it can be seen that the pitching torques Ty1 and Ty2 cancel each other out, and that the pitching torque (Ty1+Ty2) is almost zero at any position of the coil.

FIG. 10, in part (c) shows the results of analysis for the case where the height offset of the pitching torque of the voice coil 34 is-3 mm (ΔZ=−3 mm), that is, it is offset by 3 mm towards the base side. In this case, it can be seen that pitching torques Ty1 and Ty2 are generated on the outer circumferential side and inner circumferential side of the magnetic disk at approximately the same magnitude and in the same direction, and as a result, the pitching torque (Ty1+Ty2) is amplified.

It is understood here that if the directions of the height offset ΔZ are different, the pitching torque is amplified in the opposite direction. That is, it can be understood that, when a lower magnet M1 and an upper magnet M2 of different thicknesses are used in the VCM 24, the height offset of the center axis C2 of the voice coil 34 with respect to the center axis C1 between the bearings should preferably be directed to the side of the upper magnet M2 having a greater thickness.

As described above, in the HDD of this embodiment, by making the upper magnet M2 of the VCM 24 as thick as possible, the free space above the VCM 24 in the housing can be utilized effectively, and further the thrust torque of the VCM 24 can be improved.

Further, as described before, the voice coil 34 and the support frame 33 are disposed so that the center axis C2 of the voice coil 34 is offset by ΔZ in the height direction Z with respect to the center axis C1 of the actuator assembly 22 (an axis passing through the center CZ between the bearings 28a and 28b and perpendicular to the support shaft 31). The center axis C2 of the voice coil 34 is offset by ΔZ (in one example, ΔZ=3 mm) in the upper direction with respect to the center axis C1 of the actuator assembly (the cover 14 side), that is, on the side of the upper magnet M2 having a greater thickness.

As shown in FIG. 10, in part (b), even when the VCM 24 is configured asymmetrically in upper and lower directions, that is, for example, even when the thicknesses of the upper and lower magnets M1 and M2 are different from each other, it is possible to suppress the generation of pitching torque acting on the actuator assembly. That is, according to this embodiment, it is possible to provide a disk drive that can suppress the generation of residual vibration caused by the voice coil motor and improve positioning accuracy.

Note that the value of the height offset ΔZ is not limited to 3 mm, and it can be varied according to the thickness of the magnet, the number of magnetic disks and the like. The magnitude of the height offset ΔZ should preferably be adjusted within a range of 0.3 mm or more and 3 mm or less.

In addition, the configuration is not limited to one that cancels out the pitching torque Ty1 and Ty2 by 100%. For example, even if the cancelling ratio is around 80%, the pitching torque can be reduced and the performance of the HDD can be improved. For example, in the state where the magnetic head 17 is moved to the innermost circumferential or outermost circumferential position of the magnetic disk 18, it suffices if the absolute value of the difference between the absolute values of the pitching torque Ty1 and pitching torque Ty2 is 20% or less with respect to the absolute value of the pitching torque Ty1, that is,
(|Ty2|−| Ty1|)/| Ty1|≤0.2, and the height offset ΔZ is adjusted so that the direction of the torque is reversed.

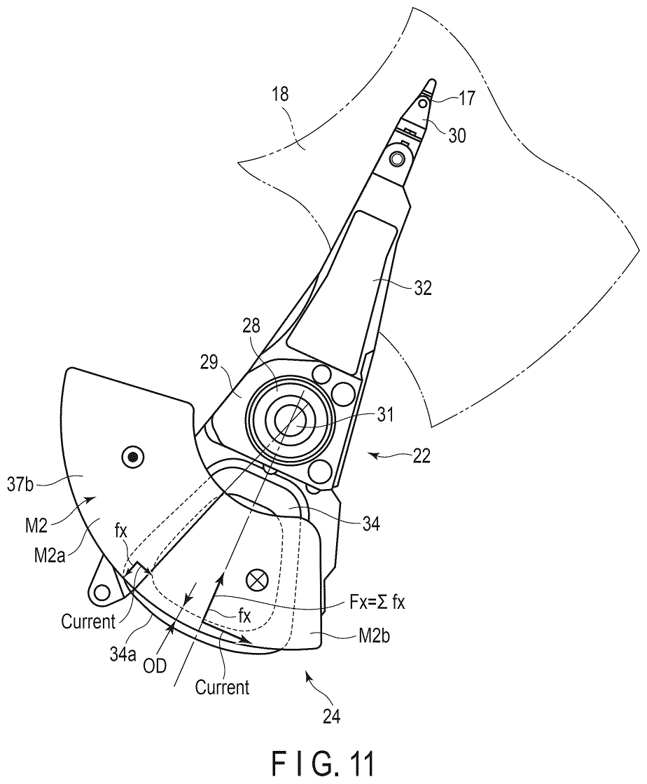

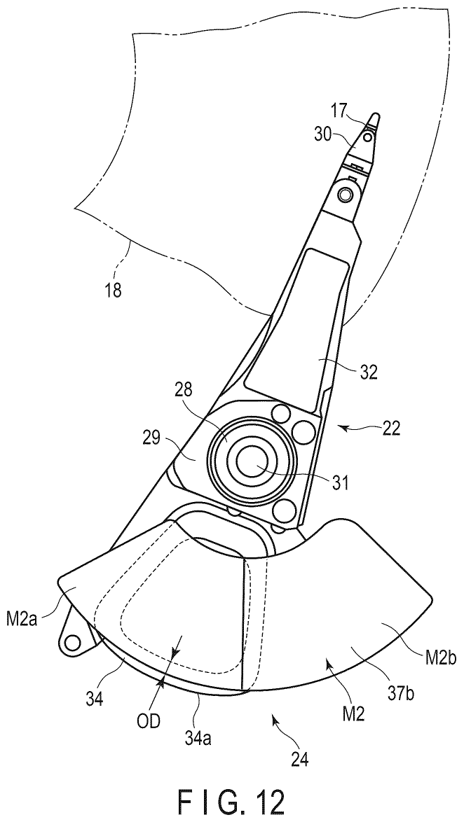

FIG. 11 is a plan view showing the state where the actuator assembly 22 has been pivoted to the inner circumferential side of the magnetic disk, and FIG. 12 is a plan view showing the state where the actuator assembly 22 has been pivoted to the outer circumferential side of the magnetic disk.

Here, in order to cancel out the pitching torque, the magnitude of Fx as well is one of the adjustment parameters in addition to the height offset ΔZ described above. The resultant force Fx in the longitudinal direction X is generated mainly at the overlap section where the outer circular arc portion 34a of the substantially fan-shaped voice coil 34 and the lower magnet M1 and upper magnet M2 overlap in the height direction Z. Therefore, the value of Fx can be adjusted by adjusting the overlapping width D between the magnets and the coil circular arc portion 34a.

As shown in FIG. 11, the resultant force Fx is represented by the sum of the forces fx generated at various parts of the circular arc portion 34a of the voice coil 34 (Fx=Σfx). In the magnetization regions M1a and M1b (M2a and M2b) of the magnets M1 and M2, the magnetization directions are opposite to each other. With this configuration, the force fx generated at each part of the circular arc portion 34a has an opposite vector direction of force fx between the site opposing the magnetization region M1a (M2a) and the site opposing the magnetization region M1b (M2b).

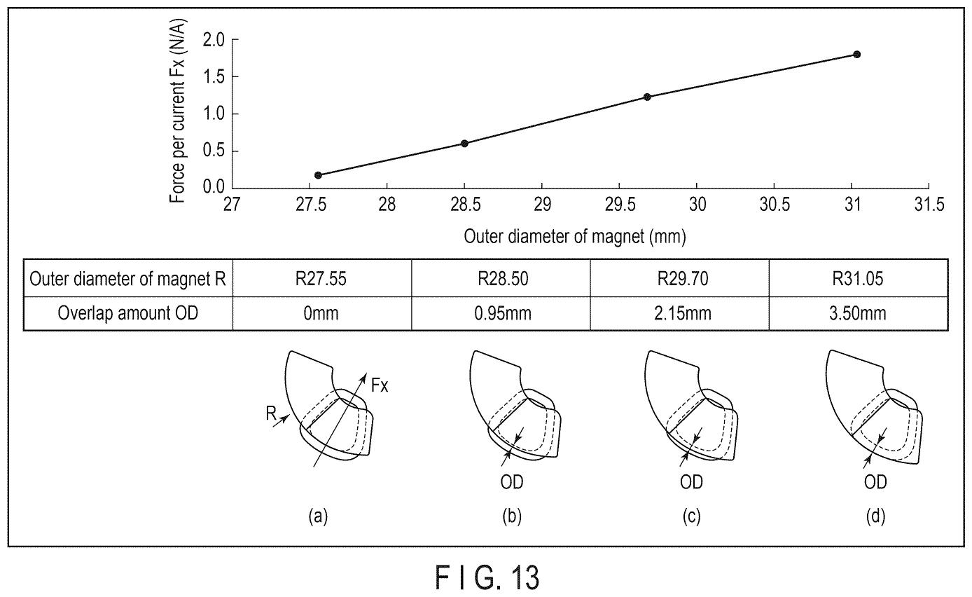

FIG. 13 is a diagram schematically showing the relationship between the width of the portion where the outer circumferential arc portion 34a of the voice coil overlaps the magnets M1 and M2 (overlapping width OD) and the magnitude of the force Fx generated in the voice coil 34.

As shown in FIG. 13, from part (a) to part (d), when the overlapping width OD is set to 0 mm, 0.95 mm, 2.15 mm, and 3.5 mm, it can be seen that as the overlap width OD is greater, the value of the resultant force Fx per unit current is greater. Therefore, by adjusting the resultant force Fx, it is possible to adjust the generated pitching torque Ty2 and to set the value of the pitching torque Ty1 to cancel out, and thus advantageous effects similar to those of the embodiment provided above can be achieved.

Note that in the embodiment described above, such a case is provided that the thicknesses d1 and d2 of the magnets M1 and M2 are different from each other of a configuration example in which the VCM has an asymmetrical structure in upper and lower directions, the configuration is not limited to that of this example, but other configuration examples may as well be used. Another example of an asymmetrical configuration in upper and lower direction is one in which the thicknesses of the magnets M1 and M2 are the same (d1=d2), and the thicknesses of the lower yoke 37a and upper yoke 37b are different from each other.

Next, an HDD of another embodiment will be explained. In the other embodiments described below, the same reference symbols are used for the same parts as in the first embodiment described above, and the detailed explanations of these parts are omitted or simplified, and the parts that differ from those of the first embodiment will be explained in detail.

### Second Embodiment

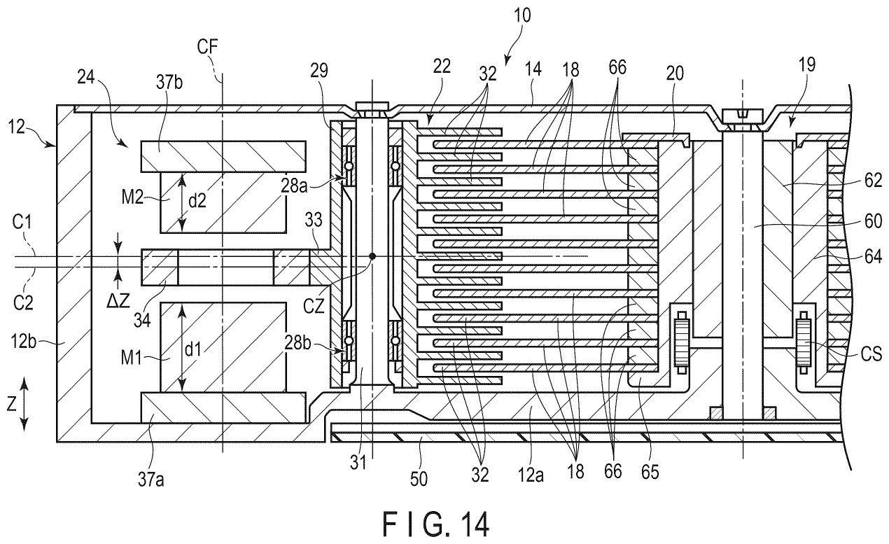

FIG. 14 is a cross-sectional view of the HDD, including a bearing unit of an actuator assembly, a voice coil motor (VCM), and a spindle shaft of a spindle motor of the HDD according to the second embodiment.

The HDD of the second embodiment is different from the first embodiment in the dimensions and arrangement of the printed circuit board 50 and the asymmetric structure of the VCM.

As shown in FIG. 14, in the second embodiment, the printed circuit board 50 is formed to be about two-thirds the size of the area of the bottom wall 12a. The printed circuit board 50 is disposed in a shallow recess formed in the bottom wall 12a. The printed circuit board 50 is provided in a region of the bottom wall 12a, which oppose the magnetic disk 18, and is located to be offset from a region opposing the VCM 24. In other words, the printed circuit board 50 does not overlap the region opposing the VCM 24.

When the dimensions and arrangement of the printed circuit board 50 are set to those as described above, a space margin is created in the region below the VCM 24. In the VCM 24, the thickness d1 in the height direction Z of the lower magnet M1 is different from the thickness d2 in the height direction Z of the upper magnet M2. In other words, the VCM24 has an asymmetrical configuration in upper and lower directions. In this embodiment, the lower magnet M1 is thicker than the upper magnet M2, which can be expressed as d1>d2.

The voice coil 34 supported by the actuator assembly 22 is located between the lower magnet M1 and the upper magnet M2, and opposes these lower magnet M1 and upper magnet M2. The voice coil 34 is arranged so that its longitudinal center axis C2 is located offset by ΔZ in the height direction Z from the center axis C1 of the actuator assembly 22, which passes through the center CZ between the two bearings 28a and 28b. In this embodiment, the voice coil 34 is located offset by the magnitude of ΔZ on the side of the bottom wall of the base, that is, the side of the thicker lower magnet M1, with respect to the center axis C1. With this configuration, the center axis C2 of the voice coil 34 is positioned at the center in the height direction Z of the distance between the lower magnet M1 and the upper magnet M2 in the height direction Z.

The magnitude of the height offset ΔZ is adjusted in the range of 0.3 to 3 mm, for example, according to the thickness of the magnet, the number of magnetic disks installed and the like.

In the second embodiment, the other components of the HDD are common to those of the HDD of the first embodiment. In the second embodiment of the above configuration as well, advantageous operational effects similar to those of the first embodiment described above can be obtained. That is, according to the second embodiment, it is possible to provide a disk drive that can suppress the occurrence of residual vibration caused by the voice coil motor and improve positioning accuracy.

### Third Embodiment

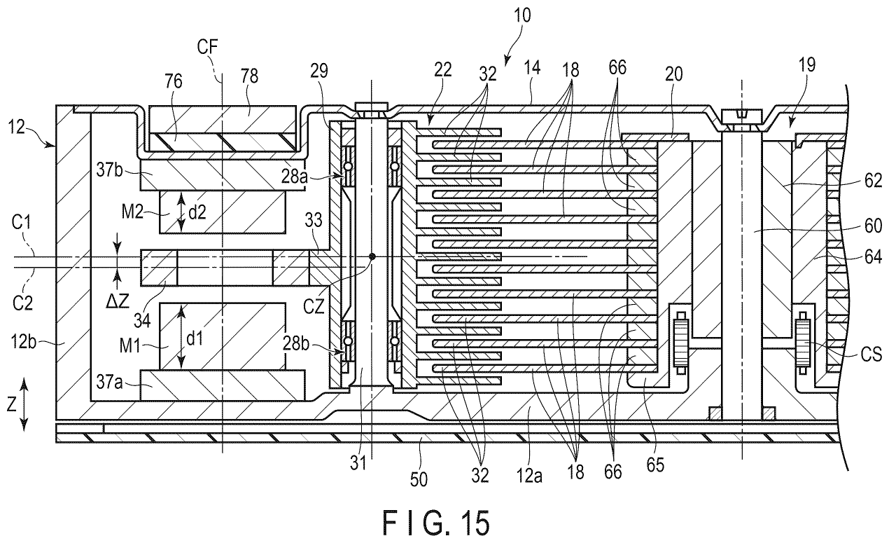

FIG. 15 is a cross-sectional view of an HDD including a bearing unit of an actuator assembly, a voice coil motor (VCM), and a spindle shaft of a spindle motor of the HDD according to the third embodiment.

The HDD of the third embodiment is different from that of the first embodiment in the dimensions and arrangement of the printed circuit board 50 and the asymmetric structure of the VCM.

As shown in FIG. 15, according to the third embodiment, the printed circuit board 50 is formed to be approximately the same size as the area of the bottom wall 12a. The printed circuit board 50 is arranged to oppose substantially the entire area of the bottom wall 12a. Further, in the cover 14, a recess is provided in the region opposing the VCM 24, and a damping plate 78 is disposed in this recess. The damping plate 78 is affixed to the cover 14 by means of the adhesive layer 76.

In the HDD having the above configuration, the upper magnet M2 of the VCM 24 is formed to be less in thickness than the lower magnet M1. That is, the thickness d1 of the lower magnet M1 in the height direction Z is different from the thickness d2 of the upper magnet M2 in the height direction Z, and the VCM 24 has a configuration asymmetrical in the upper and lower directions. As described above, in this embodiment, the lower magnet M1 is made thicker than the upper magnet M2, which can be expressed as d1>d2.

The voice coil 34 supported by the actuator assembly 22 is located between the lower magnet M1 and the upper magnet M2, and opposes these magnets. The voice coil 34 is arranged so that its longitudinal center axis C2 is located offset by ΔZ in the height direction Z from the center axis C1 of the actuator assembly 22, which passes through the center CZ between the two bearings 28a and 28b. In this embodiment, the voice coil 34 is located offset by ΔZ on the side of the bottom wall of the base, that is, the side of the thicker lower magnet M1, with respect to the center axis C1. With this configuration, the center axis C2 of the voice coil 34 is positioned at the center in the height direction Z of the distance between the lower magnet M1 and the upper magnet M2 in the height direction Z.

The magnitude of the height offset ΔZ is adjusted in the range of 0.3 to 3 mm, for example, according to the thickness of the magnet, the number of magnetic disks installed, and the like.

In the third embodiment, the other components of the HDD are common to those of the HDD of the first embodiment. In the third embodiment of the above configuration as well, advantageous operational effects similar to those of the first embodiment described above can be obtained. That is, according to the third embodiment, it is possible to provide a disk drive that can suppress the occurrence of residual vibration caused by the voice coil motor and improve positioning accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the magnetic disk device, the number of magnetic disks and the number of magnetic heads may be increased or decreased as needed, and the size of magnetic disks can be selected in various ways.

What is claimed is:

1. A disk device comprising:
a housing including a base with a bottom wall and a cover opposing the bottom wall;
a disk-shaped recording medium provided to be rotatable in the housing;
a head which performs information processing on the recording medium;
an actuator assembly including an actuator block supported to be rotatable by a pair of bearings on a support shaft extending in a first direction and provided to stand upright on the bottom wall, a suspension assembly extending from the actuator block in a direction intersecting the support shaft, on which the head is mounted, and a support frame extending from the actuator block; and
a coil motor which pivots the actuator assembly,
wherein
the coil motor comprises a lower yoke provided on the bottom wall, a lower magnet provided on the lower yoke, an upper yoke opposing the lower yoke at an interval therebetween in the first direction, an upper magnet provided on the upper yoke and opposing the lower magnet at an interval in the first direction, and a voice coil fixed to the support frame of the actuator assembly and located between the lower magnet and the upper magnet, and the upper magnet and the lower magnet are different from each other in thickness in the first direction,
the actuator assembly includes a first center axis passing through a center between the pair of bearings and perpendicular to the support shaft, and
the voice coil includes a coil center axis extending parallel to the first center axis while passing through the center in the first direction, and the coil center axis is disposed at a height position offset in the first direction with respect to the first center axis.

2. The disk device of claim 1, wherein
the voice coil is disposed at a height position offset on a side of the upper magnet or the lower magnet having a thickness greater than that of an other.

3. The disk device of claim 1, wherein
the thickness of the upper magnet in the first direction is thicker than the thickness of the lower magnet in the first direction, and
the voice coil is disposed such that the coil center axis thereof is located at a height position offset on a side of the upper magnet with respect to the first center axis.

4. The disk device of claim 1, wherein
the thickness of the lower magnet in the first direction is thicker than the thickness of the upper magnet in the first direction, and
the voice coil is disposed such that the coil center axis thereof is located at a height position offset on a side of the lower magnet with respect to the first center axis.

5. The disk device of claim 1, wherein
an amount of offset at the height position is 0.3 mm or more and 3 mm or less.

6. The disk device of claim 3, further comprising:
a printed circuit board disposed to oppose an outer surface of the bottom wall,
wherein
the printed circuit board is disposed off from a region of the bottom wall, which opposes the recording medium, and opposed to a region of the bottom wall, which opposes the coil motor.

7. The disk device of claim 4, further comprising:
a printed circuit board disposed to oppose an outer surface of the bottom wall,
wherein
the printed circuit board is disposed off from a region of the bottom wall, which opposes the coil motor, and opposed to a region of the bottom wall, which opposes recording medium.

8. The disk device of claim 1, wherein
when the head is at an innermost circumferential or outermost circumferential position of a data recording area of the recording medium, a magnitude of a difference in absolute value between a pitching torque due to a force (Fz) in the first direction generated in the voice coil and a pitching torque due to a force (Fx) in a direction of the coil center axis, generated in the voice coil is 20% or less of a magnitude of the pitching torque due to the force (Fz) in the first direction, and directions of the torques are opposite to each other.

9. The disk device of claim 1, wherein
the voice coil includes an outer circular arc portion, and at least a part of the outer circular arc portion overlaps the lower magnet and the upper magnet in the first direction.
